(19) United States
(12) Patent Application Publication
(10) Pub. No.: US 2017/0224068 A1
(43) Pub. Date: Aug. 10, 2017

(54) ITEM HAVING A CLASP APPARATUS TO RELEASABLY SET AT LEAST ONE INTERCHANGEABLE ORNAMENTAL OBJECT

(71) Applicant: Paul Derrick Williams, Silkstone (AU)

(72) Inventor: Paul Derrick Williams, Silkstone (AU)

(21) Appl. No.: 15/429,043

(22) Filed: Feb. 9, 2017

Related U.S. Application Data
(60) Provisional application No. 62/293,387, filed on Feb. 10, 2016.

(51) Int. Cl. A44C 17/02; A44C 25/00; A44C 7/00; A44C 15/00; A44C 5/00; A44C 1/00; A41F 9/00; A41D 27/08; A43B 23/24; A45D 8/24; A45D 8/34; A44B 5/02; A44B 11/00; A01K 13/00; A45C 3/06; A45C 13/08; A44C 9/00

(52) U.S. Cl. CPC A44C 17/02; A44C 9/00; A44C 25/001; A44C 7/002; A44C 15/005; A44C 5/00; A44C 15/009; A44C 1/00; A44C 25/007; A41F 9/002; A41D 27/08; A43B 23/24; A44C 15/0035; A45D 8/24; A45D 8/34; A44B 5/02; A44B 11/001; A01K 13/00; A45C 3/06; A45C 13/08; A45D 2008/006

(57) ABSTRACT

A item having a clasp apparatus to releasably set at least one interchangeable ornamental object, with variations and alternatives of the embodiments. Jewelry items and other items is configured with a clasp apparatus that allows the user to quickly and easily interchange ornamental objects such as faceted gemstones, cabochons, metal objects etc. Other uses of the embodiments comprise a relaxation or therapy aid; use as a toy; an educational tool; and an amusement apparatus.

### CROSS-REFERENCE TO RELATED APPLICATIONS

This application claims priority to and the benefit of U.S. Provisional Application Ser. No. 62/293,387 which was filed Feb. 10, 2016.

### FIELD OF THE INVENTION

The invention relates generally to the field of jewelry and other decorative or wearable items; and other uses as a relaxation or therapy aid; use as a toy; use as an educational tool; and use as an amusement apparatus. More particularly the invention related to interchangeable ornamental objects, and items configured for releasably setting the interchangeable ornamental objects.

### BACKGROUND OF THE INVENTION

Traditionally, different types of jewelry items such as rings, earrings, pendants, bracelets etc is adorned with one or more permanently set ornamental objects such as gemstones and cabochons which is well known in the art. All of these teachings demonstrate limitations that embodiments of the herein invention overcomes.

Using a common example, a ring adorned with a gemstone such as a ruby is embodied with prongs, or any number of other different types of ways to permanently set a gemstone into a ring, depending on the type, style, size and purpose of the ring. The ruby is permanently set into the ring because the prongs on the ring applies a permanent gripping force to the ruby to make sure that is does not become dislodged from the ring.

A gemstone permanently set into a ring or other jewelry item in some situations may be a desirable outcome, for example, if the gemstone is a diamond and is required to be permanently set into an engagement ring. However, in other situations a wearer may want to quickly and easily change a gemstone(s) in a jewelry item to meet their preferences. For example, a wearer may have a jewelry set such as a matching ring, set of earrings and a pendant with each individual item being embodied with permanently set blue sapphires. However, the jewelry set with the blue sapphires may not cosmetically match a red dress or any other number of clothing items in the opinion of the wearer. Or, the wearer may simply want different colored gemstones in that particular jewelry set for personal tastes.

The problem is that the wearer can't change the gemstones in that jewelry set because the gemstones are permanently set into each jewelry item. Some wearers may have the technical ability to change the ornamental objects (gemstones etc) but risks damaging both the ornamental objects and the jewelry setting in the process; as permanently setting and removing ornamental objects to jewelry is work for those skilled in the art. The only logical solution for the wearer is to buy another set of the same jewelry, if available, with different colored gemstones, if available. This may become costly especially if the jewelry setting is made of a precious metal such as platinum, gold or sterling silver.

Some attempts have been made to overcome this problem. For example, CA Pat. No. 2621143 C (Smith) describes a jewelry insert that is configured for detachable attachment to an item configured with a receptacle to receive the insert. This allows for a range and style of inserts to be interchanged among a range of receiving jewelry items. However, the invention is not suited for various types of interchangeable gemstones by themselves because the inserts need to be specifically designed to fit securely and releasably into the receiving items. Ornamental objects such as gemstones and cabochons etc, by themselves cannot be added and interchanged to these receiving jewelry items.

In another example, U.S. Pat. No. 2006/0032270 A1 (Doyno) describes a ring that receives a gemstone that is pre-set into a metal or other type of rigid setting. A clear limitation of this invention is that gemstones, cabochons etc cannot be added to the receiving ring unless they are first pre-set into a setting plus the receiving ring must also be configured to receive the screw in setting. Ornamental objects such as gemstones and cabochons etc, by themselves cannot be added and interchanged to these receiving jewelry items.

In yet another example, U.S. Pat. No. 2013/0019635 A1 (Patterson) describes a ring that allows a gemstone by itself to be added to the ring without the need of the gemstone being permanently fixed to a setting before being added to the ring. However, the assembly still has limitations because it is bulky and lacks a simplified mechanism for interchanging gemstones and a significant part of the mechanism covers the gemstones, reducing cosmetic appeal.

These examples has many limitations as shown and there is clearly a need for an invention that overcomes these limitations as will be clearly outlined in the description of the disclosed embodiments of the invention.

### SUMMARY OF THE INVENTION

The following presents a simplified summary of the invention in order to provide a basic understanding of some aspects of the invention. It is intended to neither identify all the elements and configurations of the invention nor delineate the scope of the invention. Its purpose is to present some concepts of the invention in a simplified form as to preclude the more detailed description that is presented later.

A jewelry item and other types of items as further described in the disclosure having a clasp apparatus to releasably set at least one or more interchangeable ornamental objects, the clasp apparatus comprising: at least one movable setting member that is connected to a jewelry item or other type of item; at least one tensioning mechanism configured adjacent to the at least one movable setting member to releasably set the at least one interchangeable ornamental object. The jewelry item or other type of item having a clasp apparatus to releasably set at least one interchangeable ornamental object, further comprises at least one ornamental object.

Another object of the invention is to provide a method for releasably setting at least one interchangeable ornamental object to a item.

An object of the invention is to provide different embodiments of a item having a clasp apparatus to releasably set at least one interchangeable ornamental object. The different embodiments and alternatives and variations are in keeping with the scope of the invention. Some embodiments, variations and alternatives is configured to allow pivotal rotation of at least one setting member; and other embodiments, variations and alternatives is configured to allow back and forth rotation of at least one setting member. Other directions of movement can be configured in other embodiments.

The Jewelry items and other receiving items configured with these different embodiments, variations and alternatives, is chosen from a range of jewelry items and other wearable or decorative items such as but not limited to hair ties, handbags, buckles, shoes and the like. The ornamental object(s) is chosen from a range of different objects such as but not limited to faceted gemstones, cabochons, emblems, and the like.

Another object of the invention is to provide a item having a clasp apparatus to releasably set at least one interchangeable ornamental object for use as a relaxation or therapy aid; use as a toy; use as an educational tool; and use as an amusement apparatus.

### BRIEF DESCRIPTION OF THE DRAWINGS

FIG. 1 is a general view of the first embodiment of a item having a clasp apparatus to releasably set an interchangeable ornamental object; with a releasably set interchangeable ornamental object.

FIG. 2 is a front upright view of two setting members of first embodiment before connection.

FIG. 3 is an isometric view of the connected setting members of the first embodiment showing the elastic device that supplies tension.

FIG. 4 is a close up aerial view of the top section of the two setting members of the first embodiment.

FIG. 5 is a view of a two-component connecting mechanism.

FIG. 6 is a view of an elastic device

FIG. 7 is a close up aerial view of the top section of the two setting members and some other components of the first embodiment, to explain connection.

FIG. 8 is a partial front view of how gripping portions grip an interchangeable ornamental object in the first embodiment.

FIG. 9 shows a jewelry item.

FIG. 10 is a view of the second embodiment in the open position.

FIG. 11 is a general view of the second embodiment in the closed position with a releasably set interchangeable ornamental object.

FIG. 12 is a view of some components of a setting member of the second embodiment.

FIG. 13 shows a partial view of the underside or back portion of a setting member in the second embodiment, where the arms of the elastic device is disposed.

FIG. 14 shows how setting members of the second embodiment overlap for connection.

FIG. 15 is a view of the components of the setting members of the second embodiment.

FIG. 16 shows the top aerial view of the third embodiment with a releasably set interchangeable ornamental object.

FIG. 17 is a partial view of some components of the third embodiment with the setting members in the closed position with no interchangeable ornamental object.

FIG. 18 shows a view of the fourth embodiment with a releasably set interchangeable ornamental object.

FIG. 19 is a view of a cog mechanism that is an alternative configuration.

FIG. 20 is a view of a fastening mechanism and an example of how it can be configured in an embodiment.

FIG. 21 shows a holding basket for holding interchangeable ornamental object(s) in some embodiments.

FIG. 22 shows a holding basket with an interchangeable ornamental object(s).

FIG. 23 shows an isometric view of the third embodiment of the invention.

### DETAILED DESCRIPTION OF EMBODIMENTS

### Explanation and Clarification of Some Components and Terminology

In the subsequent embodiments, variations and alternatives some components and terminology used is defined and explained for clarification and a clear understanding of the invention.

### Ornamental Objects

It is to be noted that an ornamental object is a term used to describe items selected from: faceted gemstones, stones, minerals, cabochons, cabochon gemstones, and the like and can be of natural origin and man-made; decorative elements, emblems, gold, silver, brass, aluminium, other metals, alloys, glass, plastics, resins, a metallic engraving, and an ornamental design element, and any other suitable material, and combinations thereof as will be understood by those skilled in the art. The ornamental object(s) can be any shape, size, color, dimension and number as required for the particular embodiment, variation and alternative. In one non-limiting example of an ornamental object being a combination of materials—a faceted blue topaz may be fixedly set in a metal setting basket, then that combination is releasably set to an item having a clasp apparatus to releasably set at least one ornamental object.

### Elastic Devices

It is to be known that the term “elastic device” refers to any device made of any suitable material that will return to its original shape when stretched. A non-limiting example is any type of spring that is suitable for use as an elastic device; any type of spring clip configuration, a spring with a lever configuration, and any elastomer. One skilled in the art could configure an elastomer such as a rubber band, and other suitable flexible devices for use as an elastic device.

It is to be noted that many different types of springs such as, but not limited to torsion springs, compression springs, constant force springs, tension springs, wire form springs, wire springs, springs with levers, other types of springs and any combination thereof can be configured for use in the embodiments, variations and alternatives as elastic devices. It is to be understood that an elastic device is a type of tensioning mechanism.

### Fastening Mechanism

A fastening mechanism is also a type of tensioning mechanism and is explained further in this disclosure. As a tensioning mechanism, a fastening mechanism(s) can be used as an alternative to an elastic device; or can be used in combination with an elastic device(s) as tensioning mechanisms. A tensioner or tensioning mechanism is a device that applies a force to create or maintain tension, but that tension can be released when manipulated.

### Releasably Set

Releasably set means that one or more ornamental objects can be added by a user to, and removed from, a item having a clasp apparatus to releasably set at least one interchangeable ornamental object.

Using the first embodiment 100 as a non-limiting example for further clarification; user opens movable setting members 101 and 102 and places a chosen ornamental object between gripping portions 101e and 102e of the setting members. User then releases the movable setting members 101 and 102 so the gripping portions 101e and 102e hold the ornamental object 106 in place. To remove the ornamental object 106, the user opens movable setting members 101 and 102 and removes ornamental object 106 from between gripping portions 101e and 102e.

Continuing with this non-limiting example, it is to be noted that when the setting members 101 and 102 are in the closed position with no ornamental object 106, the elastic device 103 supplies the tension to hold the setting members 101 and 102 in the closed position. When a user applies force and opens the setting members 101 and 102 and places the ornamental object 106 between the gripping portions 101e and 102e, then releases the applied force, the tension from the elastic device again supplies the tension for releasable gripping of the ornamental object 106. In other embodiments, variations and alternatives, a said fastening mechanism can be used as an alternative or on conjunction with a said elastic device to supply the tension.

### Releasably Connected and Fixedly Connected

The term “releasably connected” applies to connecting mechanisms used in the embodiments, variations and alternatives, and means that the said connecting mechanism is not permanently connected as a component of an embodiment, but can be removed if required. For example, a threaded two-component connecting mechanism subsequently described in this disclosure can be releasably connected from a component(s) of an embodiment, variations and alternatives.

The term “fixedly connected” applies to connecting mechanisms used in the embodiments, variations and alternatives, and means that the said connecting mechanism is permanently connected as a component of an embodiment, and although not intended to be removed, one skilled in the art could do so using significant force.

### Clasp Apparatus

It is to be understood that the term “clasp apparatus” is used in the similar sense as a clasp device, and a device. The term “clasp” describes what the apparatus does; all the components working together to clasp or grip, the interchangeable ornamental object(s)—a clasp apparatus. The clasp apparatus comprises the components that contribute to the action of releasably setting one or more interchangeable ornamental objects. It is also to be noted that in some embodiments, variations and alternatives that the jewelry item and other items as explained in this disclosure may also be configured to contribute to the action of releasably setting one or more interchangeable ornamental objects.

### EMBODIMENTS

It is to be noted that even though some embodiments are described using a term or similar terms such as “a item having a clasp apparatus to releasably set an interchangeable ornamental object,” subsequently it may be described as “the first embodiment” or whatever number that embodiment is. For example, “a first embodiment of a item having a clasp apparatus to releasably set an interchangeable ornamental object 100,” is subsequently described as “the first embodiment 100” or similar.

Considering other terminology in the embodiments, for example, a third embodiment of a item having a clasp apparatus to releasably set an interchangeable ornamental object 300, is also described as “the third embodiment 300”. The jewelry item 305 in this embodiment is a ring, so the ring is the “jewelry item having a clasp apparatus to releasably set an interchangeable ornamental object”. Therefore, the entire piece can be referred to as a “ring;” “a ring having a clasp apparatus to releasably set an interchangeable ornamental object”. The jewelry item 305 may also be a pendant, a bracelet, an earring etc, in this and other embodiments, variations and alternatives.

### First Embodiment

### Structure

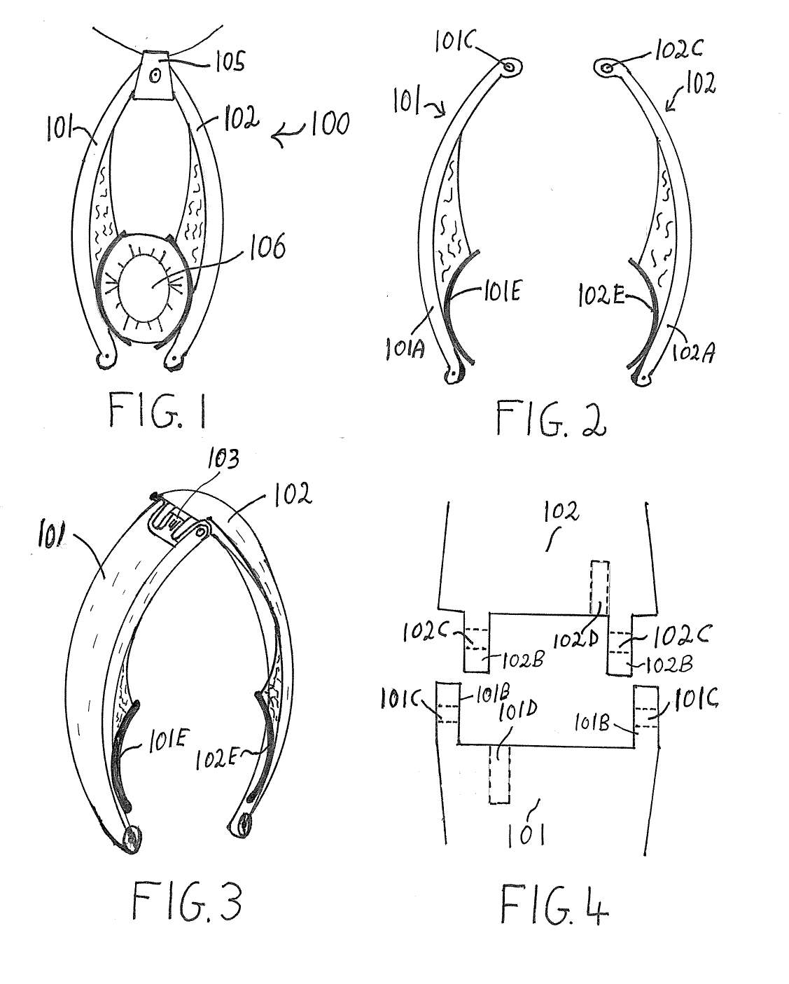

Referring now to the drawings, where FIGS. 1-9 shows a first embodiment of a item having a clasp apparatus to releasably set an interchangeable ornamental object 100, comprising two setting members 101 and 102; first setting member 101 further comprising an arm portion 101a, and extenders 101b, and sockets 101c and a receptacle 101d, and a gripping portion 101e; and a second setting member 102 further comprising an arm portion 102a, and extenders 102b, and sockets 102c, and a receptacle 102d, and a gripping portion 102e. The first embodiment 100 further comprises an elastic device 103, and a connecting mechanism 104, and a jewelry item 105. An interchangeable ornamental object 106 is releasably set to the jewelry item having a clasp apparatus to releasably set the interchangeable ornamental object 100.

In this embodiment gripping portions 101e and 102e is a part-bezel setting commonly used in the jewelry industry and clearly understood by those skilled in the art.

### Connection

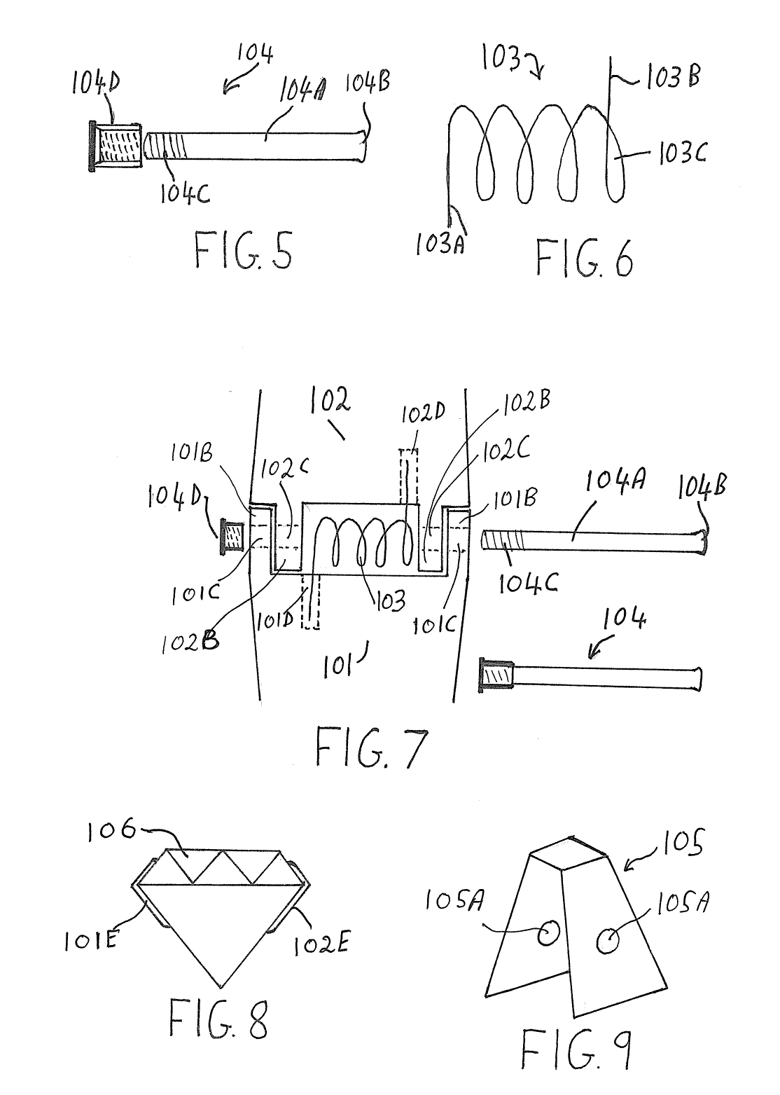

As shown in FIGS. 4-9, setting member 101 is connected to setting member 102 by the connecting mechanism 104. The connection is achieved when extenders 101b of setting member 101 is positioned adjacent to extenders 102b of setting member 102 so that lined up sockets 101c and 102c can receive connecting mechanism 104 as shown in FIG. 7. The elastic device 103 is disposed adjacent to arm portions 101a and 102a and the extenders 101b and 102b, so that the connecting mechanism 104 also passes through the cavity portion 103c of elastic device 103.

As shown in FIGS. 4 & 7, receptacle 101d is configured inside arm portion 101a, and receptacle 102d is configured inside arm portion 102a. Receptacles 101d and 102d are concave and a substantially cylindrical shape to receive lever arms 103a and 103b of elastic device 103. In this embodiment the elastic device 103 is a torsion spring with lever arms.

The arm portion 103a of elastic device 103 is disposed inside receptacle 101d, and the arm portion 103b is disposed inside receptacle 102d. This leverage provides the spring tension to force the gripping portions 101e and 102e into the closed position as shown in FIG. 1 with a releasably set interchangeable ornamental object 106, until manipulated by user to the open position.

As shown in FIG. 9, an isometric view, jewelry item 105 comprises sockets 105a. Jewelry item 105 is positioned adjacent to outside section of arm portions 101a and sockets 101c so that sockets 105a of jewelry item 105 lines up with the sockets of arm portions 101a so that connecting mechanism 104 can pass through all the said lined up sockets. FIG. 1 shows the jewelry item 105 when connected.

First component 104a of connecting mechanism 104 is inserted through socket 105a and socket 101c, and socket 102c, and through cavity portion 103c of elastic device 103, and through socket 102c and socket 101c and socket 105a, to connect the setting members 101 and 102, and the elastic device 103, and the jewelry item 105 together; when internally threaded second component 104d is attached to first component 104a, by being screwed on to threaded portion 104c of first component 104a as shown in FIGS. 5 and 7.

As shown in FIGS. 5 and 7, first component 104a of connecting mechanism 104 comprises a wider portion at the first end 104b and an externally threaded portion at the second end 104c. The wider portion 104b prevents first component 104a from completely passing through all the said sockets. The wider portion at first end 104b holds first component 104a in place at socket 105c entry point, while the externally threaded portion at second end 104c receives the internally threaded second component 104d that is disposed adjacent to socket 105a at exit point, and is screwed on to said externally threaded portion at second end 104c.

FIG. 8 shows a partial front view of how the gripping portion 101e and 102e in this embodiment grips the ornamental object 106.

### Operation/Function

A function of setting members 101 and 102 connected by coupling mechanism 104 is to pivotally rotate simultaneously, when manipulated by user to releasably set an interchangeable ornamental object 106 at users discretion.

The jewelry item having a clasp apparatus to releasably set an interchangeable ornamental object 100 fulfils a function, by a user using their fingers or a simple tool if required to open setting members 101 and 102 which are forced into the closed position by the tension supplied by elastic device 103.

When setting members 101 and 102 is opened by user, a chosen ornamental object 106 is placed between gripping portions 101e and 102e. User then releases setting members 101 and 102 so that tension from the elastic device 103 forces setting members 101 and 101 back to the closed position but with the ornamental object 106 disposed between gripping portions 101e and 102e.

### Variations and Alternatives

As a non-limiting example of an variation of embodiment 100 while keeping within the inventive concept, said variation can be configured to comprise three setting members to releasably set two said interchangeable ornamental objects. A said setting member may comprise a plurality of gripping portions in an alternative or variation.

### Second Embodiment

### Structure

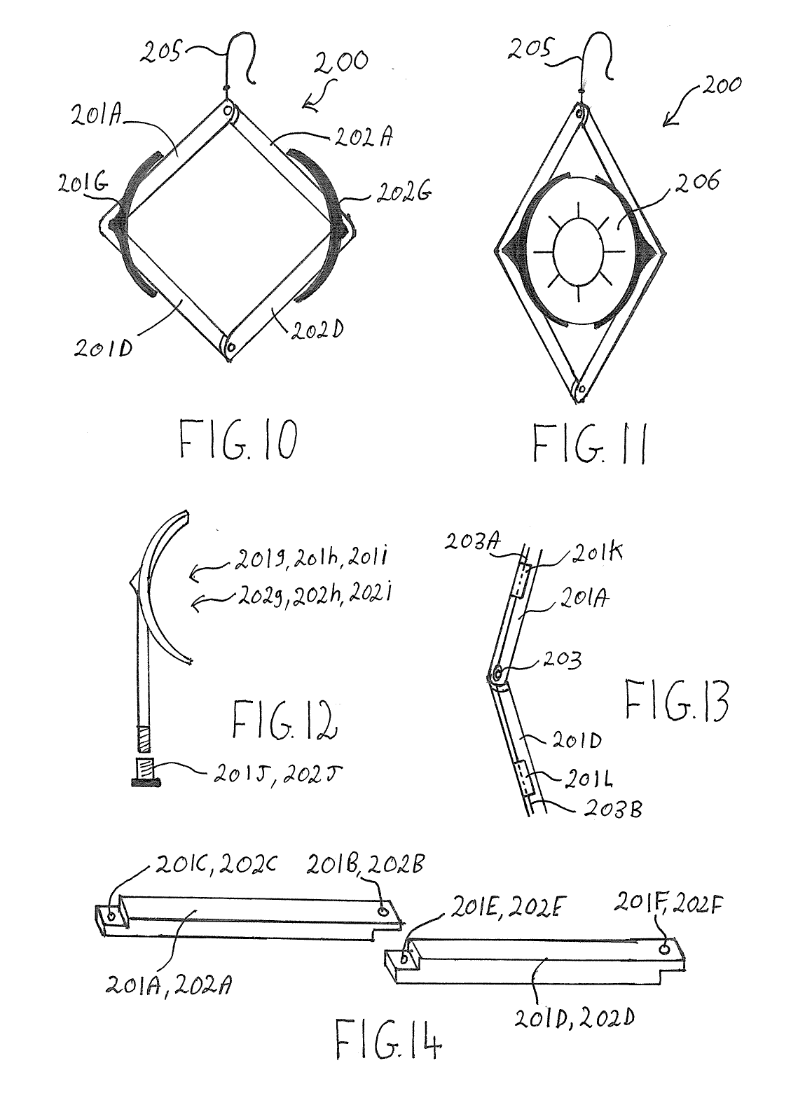

Referring now to the drawings, where FIGS. 10-15 shows a second embodiment of a item having a clasp apparatus to releasably set an interchangeable ornamental object 200, comprising two setting members 201 and 202. First setting member 201 further comprises a first arm portion 201a, further comprising sockets 201b and 201c; and a second arm portion 201d, further comprising sockets 201e and 201f; and the second setting member 202 further comprises a first arm portion 202a, further comprising socket 202b and 202c; and a second arm portion 202d, further comprising sockets 202e and 202f.

The first setting member 201 also comprises a gripping portion 201g, and an arm portion 201h with a externally threaded end 201i, and a internally threaded connector 201j. As shown in FIG. 13, the first setting member 201 also comprises a first tensioning portion 201k configured on the underside of first arm portion 201a, and a second tensioning portion 201l configured on the underside of second arm portion 201d.

The second setting member 202 also comprises a gripping portion 202g, and an arm portion 202h with a externally threaded end 202i, and a internally threaded connector 202j.

The second embodiment 200 further comprises an elastic device 203, and a two-component connecting mechanism 204, and a jewelry item 205. An interchangeable ornamental object 206 is releasably set to embodiment 200.

### Connection

First setting member 201 is assembled by connecting first arm portion 201a to second arm portion 201d by overlapping them so that socket 201b is flush with socket 201e. Substantially cylindrical arm portion 201h is placed through flush sockets 201b and 201e so that they can be connected and pivotally rotate. The internally threaded connector 201j is then screwed on to externally threaded end 201i of arm portion 201h, connecting the said components together.

Second setting member 202 is assembled by connecting first arm portion 202a to second arm portion 202d by overlapping them so that socket 202b is flush with socket 202e. Substantially cylindrical arm portion 202h is placed through flush sockets 202b and 202e so that they can be connected and pivotally rotate. The internally threaded connector 202j is then screwed on to externally threaded end 202i of arm portion 202h, connecting the said components together.

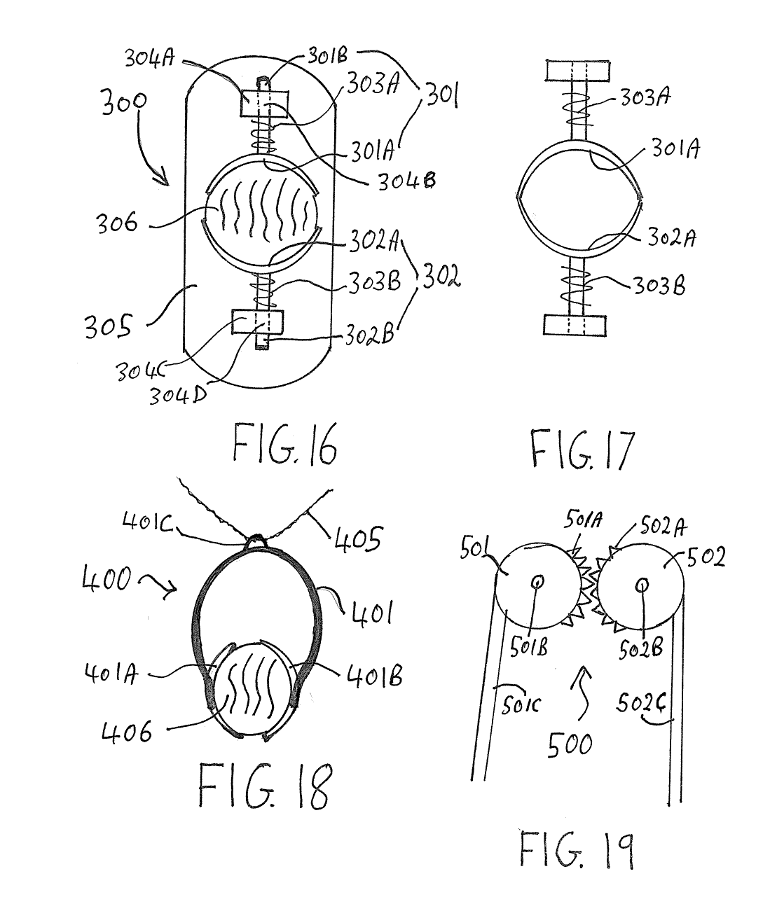

As shown in FIG. 14, the portion adjacent to sockets 201b, 201c, 201e, 201f, 202b, 202c, 202e, and 202f has less density than other portions of said arm portions. This is so that when said arm portions overlap and said sockets are flush with each other, but other configurations can be utilized. The said arm portions are substantially even. It is to be noted that FIG. 14 represents all said arm portions and said sockets of arm portions because they are substantially the same, and drawing is shown to explain the said overlapping portions.

The first setting member 201 is connected to second setting member 202 by a two-component connecting mechanism 204. Releasable connection is made by overlapping first arm portion 201a with first arm portion 202a so that socket 201c is flush with socket 202c.

Then substantially cylindrical arm portion 204b of first component 204a of connecting mechanism 204 is placed through flush sockets 201c and 202c, and the wider head portion 204a prevents first component 204a from completely passing through said sockets. The internally threaded second component 204d of connecting mechanism 204 is screwed on to externally threaded end portion 204c. The second arm portion 201d is connected to the second arm portion 202d using the same said previous steps applied to the corresponding components. This is how the setting members 201 and 202 are releasably connected end to end.

As shown in FIG. 13, elastic device 203, in this embodiment a torsion spring, is disposed on underside of first setting member 201. The cavity portion 203c is disposed around internally threaded connector 201j and the first arm portion 203a of elastic device 203 is disposed adjacent to tensioning portion 201k, and the second arm portion 203b of elastic device 203 is disposed adjacent to tensioning portion 201l.

The jewelry item 205 is connected via the connecting mechanism 204. The eye portion 205a of jewelry item 205 is disposed around substantially cylindrical arm portion 204b of first component 204a of connecting mechanism 204. The internally threaded second component 204d of connecting mechanism 204 is screwed on to externally threaded end portion 204c to releasably connect the jewelry item in position.

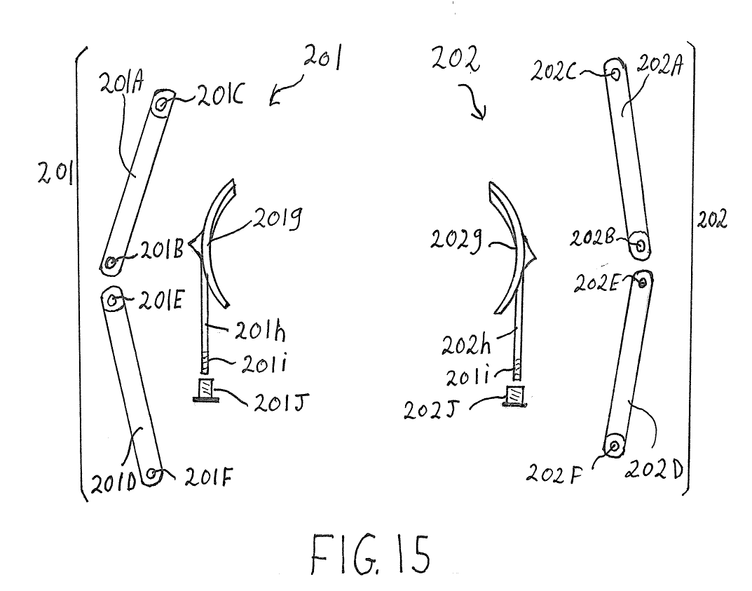

It is to be noted that FIG. 12 represents components of both setting members 201 and 202. Only one drawing is required as both said components are the same. Further clarification of individual components is shown in FIG. 15.

### Operation/Function

When a user applies compressive pressure to end portion of setting members 201 and 202, that is the end portions connected by both connecting mechanisms 204, the tension supplied by elastic device 203 allows the said arms of said setting members to pivotally rotate for releasably setting an interchangeable ornamental object 206 between gripping portions 201g and 202g.

FIG. 10 shows the open position with no interchangeable ornamental object 206. FIG. 11 shows embodiment 200 with gripping portions 201g and 202g in the closed position, gripping an ornamental objet 206.

### Variations

It is to be noted that in other variations, said gripping portion can be configured on said arm portions and variations may be configured to embody a plurality of said ornamental objects. A plurality of any type of suitable said elastic devices may also be configured in variations. Said fixed or releasable connecting mechanisms can be configured.

### Third Embodiment

### Structure

Referring now to the drawings, FIGS. 16 and 17. FIG. 16 shows an aerial view of a third embodiment of a item having a clasp apparatus to releasably set an interchangeable ornamental object 300 (the third embodiment 300), comprising two setting members 301 and 302. The first setting member 301 further comprises a gripping portion 301a and an arm portion 301b. The second setting member 302 further comprises a gripping portion 302a and an arm portion 302b. The third embodiment 300 also comprises two elastic devices 303a and 303b, and a jewelry item 305. An interchangeable ornamental object 306 is releasably set to embodiment 300, and in this non-limiting embodiment, bottom flat portion of ornamental object 306 sits flush with surface of jewelry item 305.

The setting members 301 and 302 is configured independently of each other, and the elastic devices 303a and 303b (in this example compression springs) is configured independently of each other. In this embodiment the two connecting mechanisms 304a and 304c is a fixed component of jewelry item 305. In other embodiments said connecting mechanisms may be releasably configured in the embodiment.

Other components may be configured for cosmetic and safety purposes to cover components such as elastic devices 303a and 303b.

### Connection

To releasably connect the first setting member 301 to jewelry item 305, the elastic device 303a is disposed around outside portion of the substantially cylindrical arm portion 301b of setting member 301. The arm portion 301b is disposed inside said substantially cylindrical socket portion 304b of connecting mechanism 304a, so that the substantially cylindrical arm portion 301b can freely move back and forth under tension supplied by elastic device 303a, when manipulated by user.

The elastic device 303a is prevented from entering socket portion 304b because elastic device 303a is wider than socket portion 304b. The back portion of gripping portion 301a pushes against the elastic device 303a when manipulated by user, creating the tension with elastic device 303a.

To releasably connect the second setting member 302 to jewelry item 305, the elastic device 303b is disposed around outside portion of the substantially cylindrical arm portion 302b of setting member 302. The arm portion 302b is disposed inside said substantially cylindrical socket portion 304d of connecting mechanism 304c, so that the substantially cylindrical arm portion 302b can freely move back and forth under tension supplied by elastic device 303b, when manipulated by user.

The elastic device 303b is prevented from entering socket portion 304d because elastic device 303b is wider than socket portion 304d. The back portion of gripping portion 302a pushes against the elastic device 303b when manipulated by user, creating the tension with elastic device 303a.

The connecting mechanisms 304a and 304c is configured in this embodiment to allows arm portions 301b and 302b of setting members 301 and 302 respectively, to move back and forth in a sliding motion while being held in place.

As shown in FIG. 17 in a partial view, it is to be noted that in this embodiment when setting members 301 and 302 is in the closed position, (without an ornamental object 306) where user is not manipulating said setting members to force them open; the gripping portions 301a and 302a is touching each other. This prevents setting members 301 and 302 from dislodging because of the tension supplied by elastic devices 303a and 303b.

### Operation/Function

Setting members 301 and 302 move back and forth when manipulated by user so that gripping portions 301a and 302a can releasably set an interchangeable ornamental object 306.

### Alternatives and Variations

Many different alternatives, variations and configurations of embodiment 300 is possible without departing from the scope of the invention. In a non-limiting example of an alternative embodiment; one said elastic device can be configured with one said connecting mechanism so that only one said setting member is movable. The said jewelry item can be configured so that a setting member is a fixed or releasable component of the said jewelry item without a second elastic device. Other portions of embodiment 300 and variations and alternatives can be configured with a fixed setting member, and another portion with a movable setting member to work in combination.

### Fourth Embodiment

### Structure

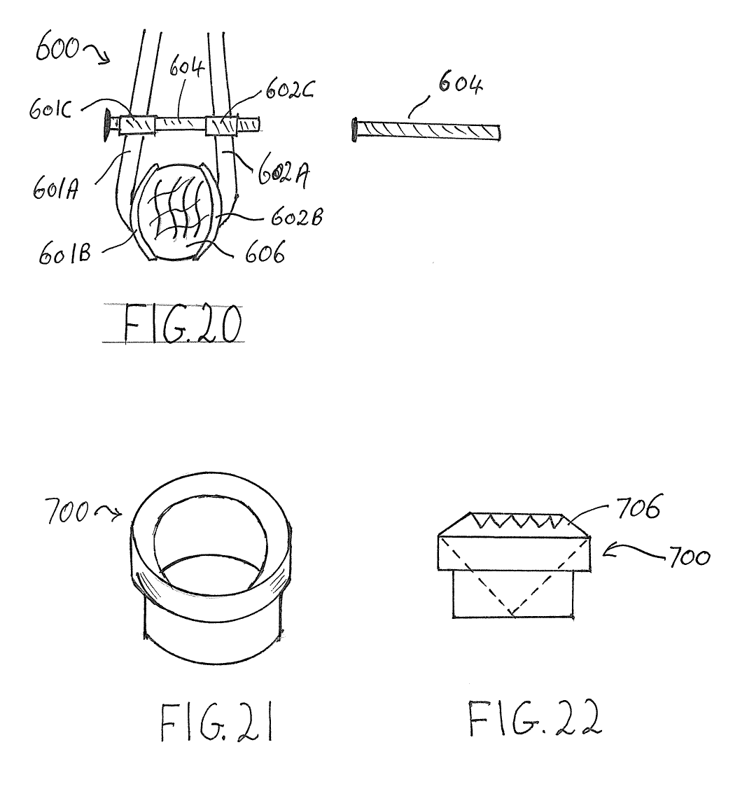

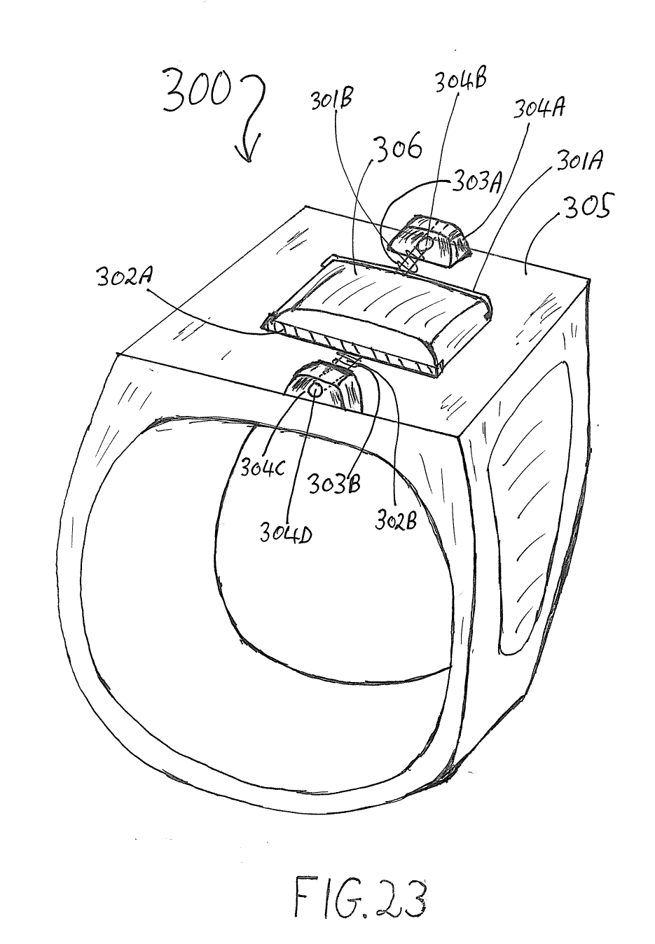

Referring now to the drawings, where FIG. 18 shows a fourth embodiment of a item having a clasp apparatus to releasably set an interchangeable ornamental object 400. The fourth embodiment 400, comprises a substantially “U” shape setting member 401, the setting member 401 also serves as a said elastic device. The setting member 401 further comprises gripping portions 401a and 401b, and a connector 401c. Embodiment 400 also comprises a Jewelry item 405.

### Connection

Jewelry item connector 402 is adjacent to outside upper portion of setting member 401; and said connector 401 is a means to provide a secure connection point for another jewelry item 405, such as a chain, an earring hook, etc. Gripping portions 401a and 401b is disposed adjacent to lower inside portions of setting member 401 as shown in FIG. 18.

### Operation/Function

The substantially “U” shape setting member 401 that also serves as a said elastic device because it is flexible and supplies tension for gripping portions 401a and 401b to releasably set an interchangeable ornamental object 406. A user uses their fingers or a simple tool to open gripping portions 401a and 401b to insert and remove (releasably set) an interchangeable ornamental object 406.

### Cog Mechanism on Setting Members

### Structure

FIG. 19, shows an embodiment 500 of how one skilled in the art can configure said setting members in some embodiments, alternatives and variations with a cog mechanism and as an alternative configuration.

This embodiment 500 comprises a first setting member 501 further comprising a cog mechanism 501a and a socket 501b, and an arm portion 501c; and a second setting member 502 further comprising a cog mechanism 502a, and a socket 502b, and an arm portion 502c. A said connecting mechanism can be used to connect the cog mechanism to a said item having a clasp apparatus to releasably set interchangeable ornamental object(s).

The cog mechanisms 501a and 502a meshes together, and sockets 501b and 502b are connected to other components of the embodiment with a said connecting mechanism. This allows for pivotal rotation of setting members 501 and 502. It is to be noted that the cog mechanism may also be referred to by some in the art as a gear mechanism.

It is to be noted that embodiment 500 can be configured to any type, size, shape and dimension as required for each embodiment, variation and alternative.

### Fastening Mechanism

### Structure

As an alternative to configuring one or more said elastic devices, an embodiment, variation and alternative may be configured with a fastening mechanism to act as a tensioning mechanism to supply tension for a said item having a clasp apparatus to releasably set one or more interchangeable ornamental objects.

FIG. 20 shows a partial view and an example of how a said fastening mechanism can be configured as an alternative tensioning mechanism in any embodiment where appropriate. FIG. 20 shows the back partial view.

An internally threaded fastening portion 601c is configured on the underside of arm portion 601a of a said setting member, and an internally threaded fastening portion 602c is configured on the underside of arm portion 602a of a said setting member. An interchangeable ornamental object 606 is releasably set between gripping portions 601b and 602b.

An externally threaded fastening portion 604 in this embodiment is a common type threaded screw which is releasably connected to internally threaded fastening portions 601c and 602c.

The components of the fastening mechanism, 604, 601c and 602c, acts as a an alternative tensioning mechanism to a said elastic device, to supply tension to releasably set at least an ornamental object 606.

A user places an ornamental object 606 between gripping portions 601b and 602b and holds them together. User then screws externally threaded fastening portion 604 into internally threaded fastening portions 601c and 602c until gripping portions 601b and 602b securely and releasably sets the ornamental object 606. User can use a tool such as a small screw driver to assist rotation of externally threaded fastening portion 604.

To release the tension supplied by said fastening mechanism, user unscrews externally threaded fastening portion 604 to release it from internally threaded fastening portions 601c and 602c.

Other said embodiments, alternatives, variations of said a item having a clasp apparatus to releasably set an interchangeable ornamental object(s) can be configured with one or more fastening mechanisms. It is to be noted that a fastening mechanism can be configured anywhere on a said embodiment, variation and alternative as required. In any embodiment, variation and alternative a tensioning mechanism can be a combination of a fastening mechanism(s) and an elastic device(s).

It is to be noted that one skilled in the art could configure other embodiments, alternatives variations and types of said fastening mechanisms such as, but not limited to, any type of suitable device comprising various types of screws, clips, clamps, magnets, screw and nut set, or any other device that supplies tension as a tensioning mechanism.

It is to be noted that both a fastening mechanism(s) and a elastic device(s) can be configured in some embodiments, variations and alternatives. With this configuration a fastening mechanism(s) can also act as a means for extra security to assist setting member(s) to releasably set interchangeable ornamental object(s). The elastic device(s) supplies the tension for releasable setting, and said fastening mechanism(s) prevents accidental dislodgment. In some embodiments, variations and alternatives a portion(s) of a fastening mechanism(s) can be configured on clasp apparatus portions, and other portion(s) of a fastening mechanism(s) can be configured on the jewelry item or other type of item.

As shown in FIG. 21, where appropriate, any embodiment, variation and alternative may be configured with a holding basket 700 to assist with the releasable setting of a said interchangeable ornamental object(s). Said jewelry items and other items may comprise a said holding basket 700 but a said holding basket may be configured on any portion of any embodiment, variation and alternative as required.

It is to be noted that in some embodiments, variations and alternatives that a holding basket can be configured with a fixed setting member. Holding basket 700 can be any shape size and dimension as required and releasably or fixedly connected. FIG. 22 shows a holding basket 700 with an interchangeable ornamental object 706. Some in the art may refer to the holding basket 700 as a setting basket, or even a setting, or something else.

### Other Variations and Alternatives

Different types of jewelry items including rings, pendants, earrings, necklaces, bracelets, anklets, bangles, chains, toe rings, pins, charms, brooches, cuff links, earring hooks, jewelry findings, connectors, tie pins, key chains, a disc, a piece of rigid material, eyewear, belts, buckles, clothing, shoes, pens, handbags, hair ties, hair clips, fashion items, decorative items, watches, watch straps, pet jewelry, body piercing jewelry, any other type of jewelry item and the like, can comprise a clasp apparatus to releasably set one or more interchangeable ornamental objects. And can be expressed in any embodiment, variation, alternative and configuration within the inventive scope.

### Elastic Devices

The configuration of a embodiment, alternative and variation, will determine the number, type and position of said elastic devices configured within the embodiment, alternative and variation.

Using said embodiment 100 as a non-limiting example of a variation or alternative; although embodiment 100 comprises one torsion spring as the elastic device 103, one skilled in the art could configure other springs, spring assemblies or other suitable types of said elastic device(s) to supply tension to grip the one or more said interchangeable ornamental objects.

For example, alternatives to a torsion spring may be a wire form spring, a flat spring, a leaf spring, a constant force spring, a coil spring, a compression spring, a tension spring or any other commonly available spring or custom made spring that may be configured to supply said tension for releasably setting one or more interchangeable ornamental objects.

In another example, an embodiment with said jewelry item comprising a predominantly filigree and petite structure, manufactured with fine, thin metal components, may require a flat or wire form spring or any other type of mechanism as a said elastic device for cosmetic or functionality purposes, or both. This will be clearly understood by those skilled in the art.

Those skilled in the art will also understand that an alternative type of said elastic device used in a said embodiment, may mean that some components of the embodiment may need to be re-configured to allow configuration of alternative type of elastic device. Again using embodiment 100 as an example, said embodiment can be configured so that lever arms 103a and 103b of elastic device 103 may be tensioned against a suitable part of the embodiment, eliminating the need for receptacles 101d and 102d in that particular example.

It is to be noted that in said embodiments that is configured with a plurality of elastic devices, the said elastic devices can be configured independently of each other as shown in a non limiting example in FIGS. 16 and 17. Any said elastic device is also considered to be a tensioning mechanism. Any said fastening mechanism is considered to be a tensioning mechanism.

### Setting Members

It is to be noted that said setting members can be configured to any size, type, shape and dimension as required and disposed in any portion of an embodiment, alternative and variation as required. Said gripping portions of setting members may be prong settings, bezel settings, or any other type of setting known and used by those skilled in the art, or any custom made gripping portion (s); configured to effectively grip the size and shape of chosen ornamental object (s) that it grips, as will also be understood by those skilled in the art.

In a non-limiting example, as shown in FIGS. 16 and 17 in the third embodiment 300, gripping portions 301a and 302a is a part-bezel setting to grip say a 10 mm×8 mm faceted oval gemstone. But in other variations and alternatives, gripping portions 301a and 302a may be a prong setting or any other suitable type of setting as required to grip a different type, size and shape ornamental object.

It is to be noted that in some embodiments of a said item having a clasp apparatus to releasably set interchangeable ornamental object(s), there may be only one setting member. Alternatively, a portion of a said item can also be configured with one or more setting member so that a interchangeable ornamental object(s) can be releasably set between the one or more setting members of clasp apparatus and the one or more setting member configured in said item. Said setting members may be configured on any portion of an embodiment, variation and alternative as required, and may even be releasably connected, but this is a design consideration.

A setting member(s) connected to a jewelry item or other item can be a direct connection, or an indirect connection with intervening components. One advantage of releasably connected setting members is that they can be changed so that the jewelry item or other item can have setting members designed for different types, sizes and shapes of interchangeable ornamental objects. It is to be noted that in some embodiments, variations and alternatives a setting member may be connected directly to a said item, or indirectly through an interconnecting component to a said item.

### Connecting Mechanisms

In the said embodiments of a item having a clasp apparatus to releasably set interchangeable ornamental object(s), it is to be noted that said connecting mechanisms can be configured to any size, type and shape as required and disposed in the embodiments, variations and alternatives where required. The term “connecting” used in the term “connecting mechanism” is intended to be inclusive in a similar manner to the term “coupling”.

FIGS. 5 and 7 shows a non-limiting example of how a connecting mechanism 104 may be configured. In other embodiments, alternatives and variations, different configurations of connecting mechanisms can be configured as required. Some connecting mechanisms may be releasable and other may be fixed, depending on the requirements.

It is to be noted that connecting mechanisms can be any type of connecting mechanism that has a function of allowing the pivotal rotation or back and forth movement of at least one setting member when manipulated by user. The embodiment, variation or alternative will determine whether the setting member(s) rotates pivotally or back and forth or in some other motion or direction.

The connecting mechanism(s) as configured in the preceding embodiments and any other embodiments, alternatives, and variations, can comprise at least one component or a plurality of components, depending on the configuration requirements, and may be fixed or releasably connected.

In some configurations using a two-component connecting mechanism, first component may be internally threaded at one end and the second component may be externally threaded, or vice versa. One skilled in the art could use different methods and configurations for a connecting mechanism such as a single component connecting mechanism that is permanently fixed to an embodiment. The said connecting mechanism can be broadened at first and second ends to prevent dislodgement after assembly.

Connecting mechanisms of all types can be configured to any size, shape and dimension etc and in some embodiments, variations and alternatives can be multi-component connecting mechanisms; and can be disposed in any portion of a said item having a clasp apparatus to releasably set interchangeable ornamental object(s).

It is to be noted that in some embodiments, variations and alternatives, components may be directly connected together or may be connected together through one or more intervening elements, either releasably or fixedly.

### Receiving Items

Some of the preceding embodiments are described as “a item having a clasp apparatus to releasably set an interchangeable object”. Other non-jewelry items including but not limited to fashion items and other items such as buckles, handbags, hair clips, hair ties, hair bands, bags, shoes, pens, key chains, watches, watch straps, toys, clips, sunglasses, eyewear, buttons, grommets, belts, clothing, and hats etc; may also be described as “a item having a clasp apparatus to releasably set one or more interchangeable ornamental objects” etc. One skilled in the art may also configure any of the said non-jewelry items to comprise any of the said embodiments, variations, alternatives or parts thereof. In a non-limiting example, a leather handbag may be configured to comprise a clasp apparatus to releasably set an interchangeable ornamental object(s)”.

### Embodiment Materials

It is to be understood that the materials of the said embodiments, alternatives and variations, comprises any known materials and combinations of materials without limitation, such as gold, silver, platinum, rhodium, other precious metals, titanium, tungsten, stainless steel, steel, brass, bronze, tin, aluminium, alloys, any other metals, minerals, glass, wood, plastics, resins, leather, PVC, polypropylene, polycarbonate and the like.

It is also to be understood that the embodiments, variations and alternatives can be manufactured with any configuration such as cosmetic appearance, shape, style, size, and dimension without departing from the general inventive concept as described and as defined in the detailed description and claims.

### Other Uses of the Embodiments, Variations and Alternatives

### Recreation and Therapy

Other non-limiting uses of the said embodiments, variations and alternatives includes uses for and methods of relaxation or therapy; use as a toy; an educational tool; and an amusement apparatus. The back and forth movement of setting member(s) under tension can be a form of relaxation and therapy, a type of toy and also amusement, as users often enjoy fiddling with devices and apparatus. The back and forth movement of setting member(s) under tension can also be used as an educational tool to demonstrate how elastic devices and other components operate.

### CONCLUSIONS, RAMIFICATIONS, AND SCOPE

Each of the said embodiments of the invention can be expressed in a plurality of alternatives, variations and configurations, without departing from the scope of the invention. This is because of the customizable nature of the embodiments and the many different types of jewelry items and other items that the embodiments comprise. Jewelry and other said items comprising the embodiments can be expressed in many different styles, shapes and dimensions and the embodiments may need to be configured with various variations and alternatives to meet those needs.

It is to be noted that where the various embodiments and alternatives, variations, examples and configurations of the invention is outlined, that all of the details of each of the said embodiments and alternatives, variations, examples and configurations, may be applicable to every other embodiment, alternatives, variations, examples and configurations, even if not specifically mentioned. They may also be applicable to other embodiments, variations and alternatives in keeping within the scope of the invention, even though not revealed within this disclosure that may be conceived at a later time.

In addition, while a particular feature of the invention may have been disclosed with respect to only one of several embodiments, such features may be combined with one or more other features of the other embodiments as may be desired and advantageous for any given or particular application.

Although the invention has been shown and described with respect to certain embodiments, variations and alternatives, it is obvious that equivalent alterations and modifications will occur to others skilled in the art upon the reading and understanding of this specification and the annexed drawings.

In particular regard to the various operations/functions performed by the above described components the terms, (including a reference to a “function” and “operation”) used to describe components, are intended to correspond, unless otherwise indicated, to any component which performs the specified operation/function of the described component (i.e. that is functionally equivalent), even though not structurally equivalent to the disclosed structure which performs the operation/function in the herein illustrated exemplary embodiments of the invention.

Furthermore, to the extent that the terms “including”, “includes”, ‘having”, “has”, “with”, or variants thereof that are used in either the detailed description and the claims, such terms are intended to be inclusive in a similar manner to the term “comprising.”

What is claimed is:

1. A item having a clasp apparatus to releasably set at least one interchangeable ornamental object, the clasp apparatus comprising:
a) at least one movable setting member being connected to said item and,
b) at least one tensioning mechanism configured adjacent to said at least one movable setting member to supply tension for said at least one movable setting member to releasably set the at least one interchangeable ornamental object.

2. The item having a clasp apparatus to releasably set at least one interchangeable ornamental object of claim 1, further comprising at least one ornamental object.

3. The at least one interchangeable ornamental object of claim 2, wherein said at least one interchangeable ornamental object is selected from the group comprising: faceted gemstones, stones, minerals, cabochons, cabochon gemstones, and the like and can be of natural origin and man-made; decorative elements, emblems, a metallic engraving, an ornamental design element; gold, silver, brass, aluminium, other metals, alloys, glass, plastics, resins, and any other suitable material and any combinations thereof as will be understood by those skilled in the art.

4. The item having a clasp apparatus to releasably set at least one interchangeable ornamental object of claim 1, wherein the alternatives, variations, configurations, shapes and dimensions of the said item having a clasp apparatus to releasably set at least one interchangeable ornamental object can vary.

5. The item of claim 1, wherein the item is selected from the group comprising rings, pendants, earrings, necklaces, bracelets, anklets, bangles, chains, toe rings, pins, charms, brooches, cuff links, earring hooks, jewelry findings, connectors, tie pins, key chains, a disc, a piece of rigid material, eyewear, belts, buckles, clothing, shoes, pens, handbags, hair ties, hair clips, fashion items, decorative items, watches, watch straps, pet jewelry, body piercing jewelry, and the like.

6. The clasp apparatus of claim 1, wherein the clasp apparatus comprises at least one elastic device; a first movable setting member further comprising at least one gripping portion, said first movable setting member connected to a second movable setting member further comprising at least one gripping portion; said connection is made by a connecting mechanism to allow pivotal rotational of said movable setting members.

7. The clasp apparatus of claim 1, wherein the clasp apparatus comprises at least one elastic device; and a first movable setting member further comprising a first and a second arm portion; said first movable setting member is connected end to end to a second movable setting member further comprising a first and a second arm portion.

8. The clasp apparatus of claim 1, wherein the clasp apparatus comprises a plurality of independently configured movable setting members; and a plurality of independently configured tensioning mechanisms, adjacent to said movable setting members, said independently configured tensioning mechanisms allows for back and forth movement of said movable setting members.

9. The item having a clasp apparatus to releasably set at least one interchangeable ornamental object of claim 1, wherein the said item further comprises at least one fixed setting member; and the clasp apparatus further comprises at least one movable setting member, and at least one tensioning mechanism.

10. The clasp apparatus of claim 1, wherein the clasp apparatus further comprises at least one fixed setting member.

11. The clasp apparatus of claim 1, wherein the said clasp apparatus comprises a substantially U shape setting further comprising a plurality of gripping portions.

12. The item having a clasp apparatus to releasably set at least one interchangeable ornamental object of claim 1, further comprising at least one holding basket.

13. The clasp apparatus of claim 1, wherein a cog mechanism is configured as a component of said a plurality of setting members.

14. The tensioning mechanism of claim 1, wherein said tensioning mechanism is an elastic device.

15. The tensioning mechanism of claim 1, wherein said tensioning mechanism is a fastening mechanism.

16. A item having a clasp apparatus comprising:
a) at least one movable setting member connected to said item and,
b) at least one tensioning mechanism configured adjacent to said at least one movable setting member.

17. The item having a clasp apparatus of claim 16, further comprising at least one ornamental object.

18. Where the item having a clasp apparatus to releasably set at least one interchangeable ornamental object of claim 1, is used as a method of relaxation, for therapeutic use, for educational use, as a toy, and for entertainment purposes.

19. A method for releasably setting at least one interchangeable ornamental object to a item, comprising:
a) providing a item having a clasp apparatus that is configured to allow for the releasable setting of at least one interchangeable ornamental object;
b) using a finger or a tool to move the at least one movable setting member into the open position;
c) placing the at least one interchangeable ornamental object adjacent to gripping portion(s) of said at least one movable setting member;
d) using a finger or a tool to release the at least one movable setting member and moving it into the closed position so that said gripping portion(s) releasably set the at least one interchangeable ornamental object.
